(19) United States
(12) Patent Application Publication
(10) Pub. No.: US 2015/0201456 A1
(43) Pub. Date: Jul. 16, 2015

(54) METHOD AND APPARATUS FOR CONFIGURING A DISCONTINUOUS RECEPTION (DRX) OPERATION IN A WIRELESS COMMUNICATION SYSTEM

(71) Applicant: LG ELECTRONICS INC., Seoul (KR)

(72) Inventors: Sunyoung Lee, Seoul (KR); Youngdae Lee, Seoul (KR); Sungjun Park, Seoul (KR); Seungjune Yi, Seoul (KR); Sunghoon Jung, Seoul (KR)

(73) Assignee: LG ELECTRONICS INC., Seoul (KR)

(21) Appl. No.: 14/415,549

(22) PCT Filed: Aug. 8, 2013
(86) PCT No.: PCT/KR2013/007143

§ 371 Date: Jan. 16, 2015

Related U.S. Application Data
(60) Provisional application No. 61/693,757, filed on Aug. 27, 2012.

(51) Int. Cl. H04W 76/04; H04W 72/04

(52) U.S. Cl. CPC H04W 76/048; H04W 72/042; H04W 72/0413

(57) ABSTRACT

A method for and apparatus for configuring a DRX (Discontinuous Reception) operation in a wireless communication system is provided. A wireless device configures that it does not to monitor a PDCCH during a Scheduling Request (SR) pending period by receiving an indication. The wireless device also modifies that an Active Time does not include the SR pending period depending on the indication, so that the DRX operation can be configured for battery saving purpose more efficiently.

### TECHNICAL FIELD

The present invention relates to wireless communications, and more particularly, to a method and apparatus for configuring a DRX operation in a wireless communication system.

### BACKGROUND ART

3rd generation partnership project (3GPP) long term evolution (LTE) is an improved version of a universal mobile telecommunication system (UMTS) and a 3GPP release 8. The 3GPP LTE uses orthogonal frequency division multiple access (OFDMA) in a downlink, and uses single carrier-frequency division multiple access (SC-FDMA) in an uplink. The 3GPP LTE employs multiple input multiple output (MIMO) having up to four antennas. In recent years, there is an ongoing discussion on 3GPP LTE-advanced (LTE-A) that is an evolution of the 3GPP LTE.

Discontinuous reception (DRX) is a method for reducing battery consumption by allowing a user equipment (UE) to discontinuously monitor a downlink channel. When the DRX is configured, the UE discontinuously monitors the downlink channel. Otherwise, the UE continuously monitors the downlink channel.

Recently, many applications require an always-on characteristic. Always-on is a characteristic in which the UE is always connected to a network so as to directly transmit data whenever necessary.

However, since battery consumption is great when the UE continuously maintains the network connection, a proper DRX is configured in a corresponding application to guarantee the always-on characteristic while reducing battery consumption.

Recently, several various applications are running in parallel in one UE, and thus it is not easy to configure one DRX suitable for all of the applications. This is because, even if an optimal DRX is configured for a specific application, it may be a not proper DRX configuration with respect to other applications which are running in parallel.

There is a need for a method for operating the DRX in a more flexible manner.

### DISCLOSURE OF INVENTION

### Technical Problem

The present invention provides a method and apparatus for configuring a DRX operation in a wireless communication system.

The present invention also provides a method and apparatus for controlling PDCCH monitoring for a DRX operation in a wireless communication system.

The present invention also provides a method and apparatus for controlling an Active time to monitor PDCCH(s) for a DRX operation in a wireless communication system.

The present invention also provides a method and apparatus for receiving an uplink grant during onDuration for a DRX operation in a wireless communication system.

### Solution to Problem

In an aspect, a method for configuring a DRX (Discontinuous Reception) operation in a wireless communication system is provided. The method may include receiving an indication indicating whether it is need to monitor a physical downlink control channel (PDCCH) or not during a Scheduling Request (SR) pending period, and controlling to monitor the PDDCH during the SR pending period according to the indication.

The method may further include configuring the Active Time does not include the SR pending period if the indication indicates that the UE does not need to monitor the PDCCH during the SR pending period.

The method may further include controlling to monitor the PDDCH during the SR pending period only if the indication indicates that the UE is configured to monitor PDCCH during the time while the Scheduling is sent on PUCCH and is pending.

In another aspect, a wireless device for configuring a DRX (Discontinuous Reception) operation in a wireless communication system is provided. The wireless device includes a radio frequency unit for receiving a radio signal; and a processor, operatively coupled with the radio frequency unit, configured to receive an indication indicating whether it is need to monitor a physical downlink control channel (PDCCH) or not during a Scheduling Request (SR) pending period, and control to monitor the PDDCH during the SR pending period according to the indication.

### Advantageous Effects of Invention

The UE can configure that it does not to monitor a PDCCH during a Scheduling Request (SR) pending period by receiving an indication. The wireless device also modifies that an Active Time does not include the SR pending period depending on the indication, so that the DRX operation can be configured for battery saving purpose more efficiently.

### BRIEF DESCRIPTION OF DRAWINGS

FIG. 1 shows a wireless communication system to which the present invention is applied.

FIG. 2 is a diagram showing a radio protocol architecture for a user plane to which the present invention is applied.

FIG. 3 is a diagram showing a radio protocol architecture for a control plane to which the present invention is applied to which the present invention is applied

FIG. 4 shows a DRX cycle to which the present invention is applied.

FIG. 5 shows active time for DRX operation to which the present invention is applied.

FIG. 6 shows an example of monitoring the PDCCH in the wireless communication system.

FIG. 7 is shows a time flow for monitoring the PDCCH during the SR pending in the wireless communication system.

FIG. 8 shows an example of a signaling flow by controlling PDCCH monitoring during a SR pending for a DRX operation according to an exemplary embodiment of the present invention.

FIG. 9 shows an example of a flow chart by checking an indication for PDCCH monitoring according to an exemplary embodiment of the present invention.

FIG. 10 shows an example of a time flow by controlling PDCCH monitoring using the indication according to an exemplary embodiment of the present invention.

FIG. 11 shows a block diagram showing a wireless communication system according to an exemplary embodiment of the present invention.

### MODE FOR THE INVENTION

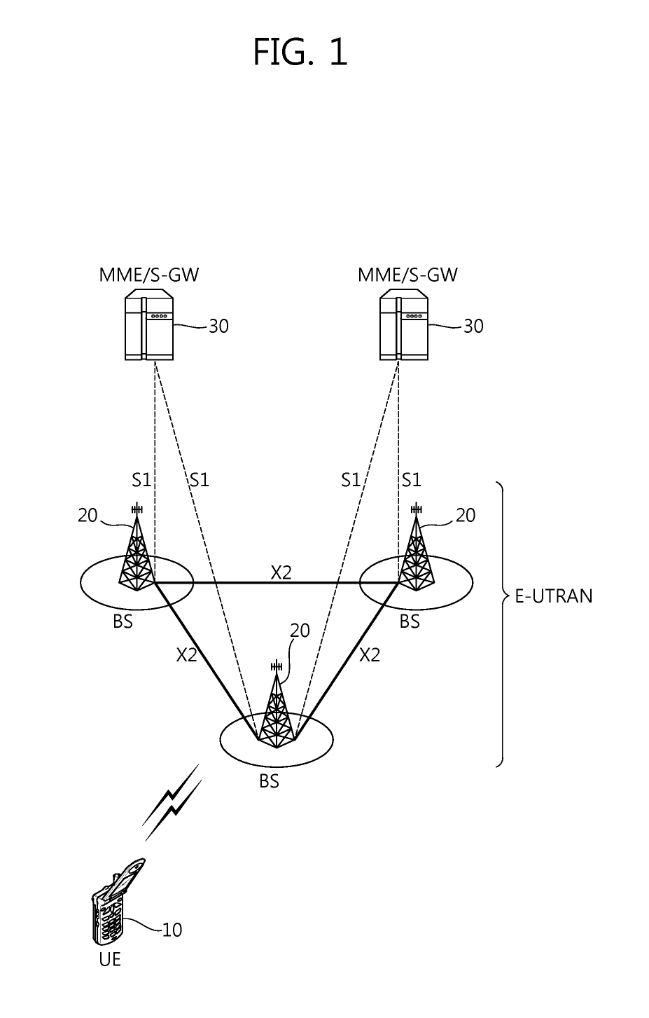

FIG. 1 shows a wireless communication system to which the present invention is applied. The wireless communication system may also be referred to as an evolved-UMTS terrestrial radio access network (E-UTRAN) or a long term evolution (LTE)/LTE-A system.

The E-UTRAN includes at least one base station (BS) 20 which provides a control plane and a user plane to a user equipment (UE) 10. The UE 10 may be fixed or mobile, and may be referred to as another terminology, such as a mobile station (MS), a user terminal (UT), a subscriber station (SS), a mobile terminal (MT), a wireless device, etc. The BS 20 is generally a fixed station that communicates with the UE 10 and may be referred to as another terminology, such as an evolved node-B (eNB), a base transceiver system (BTS), an access point, etc.

The BSs 20 are interconnected by means of an X2 interface. The BSs 20 are also connected by means of an S1 interface to an evolved packet core (EPC) 30, more specifically, to a mobility management entity (MME) through S1-MME and to a serving gateway (S-GW) through S1-U.

The EPC 30 includes an MME, an S-GW, and a packet data network-gateway (P-GW). The MME has access information of the UE or capability information of the UE, and such information is generally used for mobility management of the UE. The S-GW is a gateway having an E-UTRAN as an end point. The P-GW is a gateway having a PDN as an end point.

Layers of a radio interface protocol between the UE and the network can be classified into a first layer (L1), a second layer (L2), and a third layer (L3) based on the lower three layers of the open system interconnection (OSI) model that is well-known in the communication system. Among them, a physical (PHY) layer belonging to the first layer provides an information transfer service by using a physical channel, and a radio resource control (RRC) layer belonging to the third layer serves to control a radio resource between the UE and the network. For this, the RRC layer exchanges an RRC message between the UE and the BS.

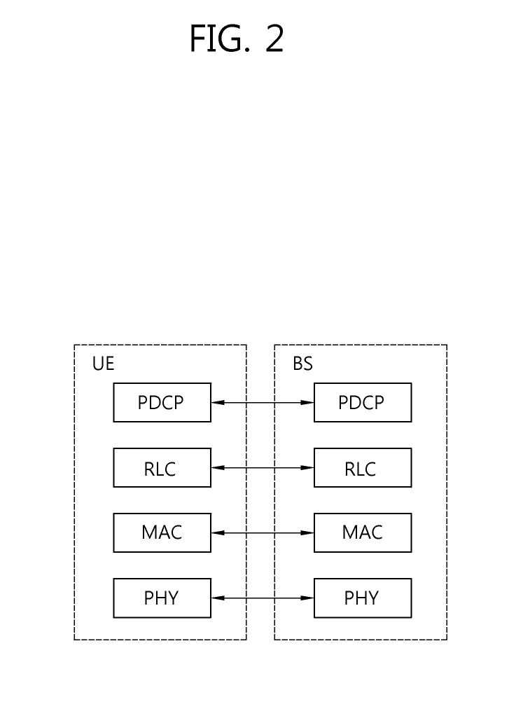

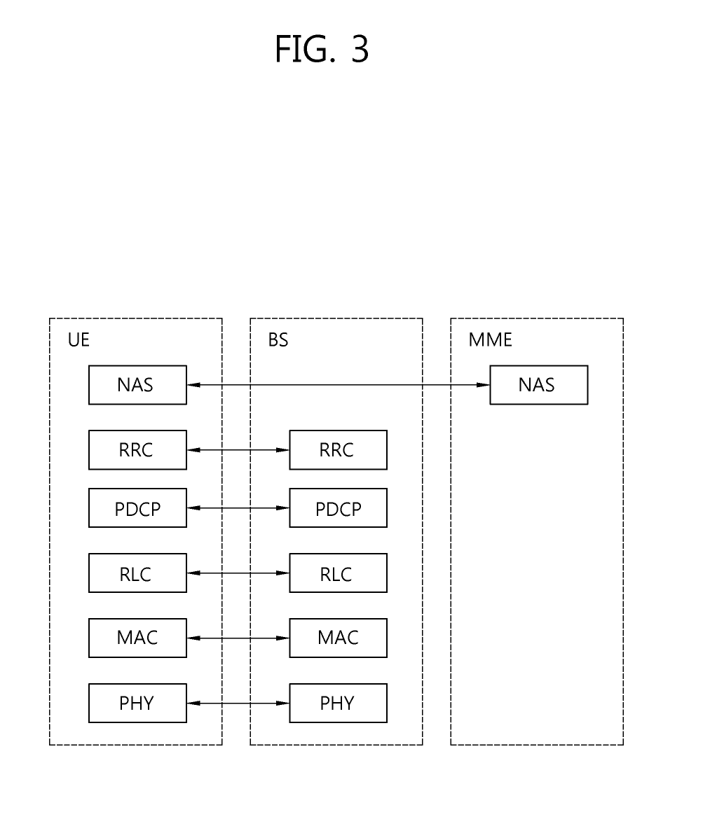

FIG. 2 is a diagram showing a radio protocol architecture for a user plane. FIG. 3 is a diagram showing a radio protocol architecture for a control plane. The user plane is a protocol stack for user data transmission. The control plane is a protocol stack for control signal transmission.

Referring to FIGS. 2 and 3, a PHY layer provides an upper layer with an information transfer service through a physical channel. The PHY layer is connected to a medium access control (MAC) layer which is an upper layer of the PHY layer through a transport channel. Data is transferred between the MAC layer and the PHY layer through the transport channel. The transport channel is classified according to how and with what characteristics data is transferred through a radio interface.

Between different PHY layers, i.e., a PHY layer of a transmitter and a PHY layer of a receiver, data is transferred through the physical channel. The physical channel may be modulated using an orthogonal frequency division multiplexing (OFDM) scheme, and may utilize time and frequency as a radio resource.

Functions of the MAC layer include mapping between a logical channel and a transport channel and multiplexing/de-multiplexing on a transport block provided to a physical channel over a transport channel of a MAC service data unit (SDU) belonging to the logical channel. The MAC layer provides a service to a radio link control (RLC) layer through the logical channel.

Functions of the RLC layer include RLC SDU concatenation, segmentation, and reassembly. To ensure a variety of quality of service (QoS) required by a radio bearer (RB), the RLC layer provides three operation modes, i.e., a transparent mode (TM), an unacknowledged mode (UM), and an acknowledged mode (AM). The AM RLC provides error correction by using an automatic repeat request (ARQ).

Functions of a packet data convergence protocol (PDCP) layer in the user plane include user data delivery, header compression, and ciphering. Functions of a PDCP layer in the control plane include control-plane data delivery and ciphering/integrity protection.

A radio resource control (RRC) layer is defined only in the control plane. The RRC layer serves to control the logical channel, the transport channel, and the physical channel in association with configuration, reconfiguration and release of radio bearers (RBs). An RB is a logical path provided by the first layer (i.e., the PHY layer) and the second layer (i.e., the MAC layer, the RLC layer, and the PDCP layer) for data delivery between the UE and the network.

The setup of the RB implies a process for specifying a radio protocol layer and channel properties to provide a particular service and for determining respective detailed parameters and operations. The RB can be classified into two types, i.e., a signaling RB (SRB) and a data RB (DRB). The SRB is used as a path for transmitting an RRC message in the control plane. The DRB is used as a path for transmitting user data in the user plane.

When an RRC connection is established between an RRC layer of the UE and an RRC layer of the network, the UE is in an RRC connected state (also may be referred to as an RRC connected mode), and otherwise the UE is in an RRC idle state (also may be referred to as an RRC idle mode).

Data is transmitted from the network to the UE through a downlink transport channel. Examples of the downlink transport channel include a broadcast channel (BCH) for transmitting system information and a downlink-shared channel (SCH) for transmitting user traffic or control messages. The user traffic of downlink multicast or broadcast services or the control messages can be transmitted on the downlink-SCH or an additional downlink multicast channel (MCH). Data is transmitted from the UE to the network through an uplink transport channel. Examples of the uplink transport channel include a random access channel (RACH) for transmitting an initial control message and an uplink SCH for transmitting user traffic or control messages.

Examples of logical channels belonging to a higher channel of the transport channel and mapped onto the transport channels include a broadcast channel (BCCH), a paging control channel (PCCH), a common control channel (CCCH), a multicast control channel (MCCH), a multicast traffic channel (MTCH), etc.

The physical channel includes several OFDM symbols in a time domain and several subcarriers in a frequency domain. One subframe includes a plurality of OFDM symbols in the time domain. A resource block is a resource allocation unit, and includes a plurality of OFDM symbols and a plurality of subcarriers. Further, each subframe may use particular subcarriers of particular OFDM symbols (e.g., a first OFDM symbol) of a corresponding subframe for a physical downlink control channel (PDCCH), i.e., an L1/L2 control channel. A transmission time interval (TTI) is a unit time of subframe transmission.

The 3GPP LTE classifies a physical channel into a data channel, i.e., a physical downlink shared channel (PDSCH) and a physical uplink shared channel (PUSCH), and a control channel, i.e., a physical downlink control channel (PDCCH), a physical control format indicator channel (PCFICH) and a physical hybrid-ARQ indicator channel (PHICH), and a physical uplink control channel (PUCCH).

The PCFICH transmitted in a 1st OFDM symbol of the subframe carries a control format indicator (CFI) regarding the number of OFDM symbols (i.e., a size of the control region) used for transmission of control channels in the subframe. The UE first receives the CFI on the PCFICH, and thereafter monitors the PDCCH.

The PDCCH is a downlink control channel, and is also called a scheduling channel in a sense that it carries scheduling information. Control information transmitted through the PDCCH is referred to as downlink control information (DCI). The DCI may include resource allocation of the PDSCH (this is referred to as a downlink (DL) grant), resource allocation of a PUSCH (this is referred to as an uplink (UL) grant), a set of transmit power control commands for individual UEs in any UE group and/or activation of a voice over Internet protocol (VoIP).

The wireless communication system as 3GPP LTE of the present invention uses blind decoding for PDCCH detection. The blind decoding is a scheme in which a desired identifier is de-masked from a CRC of a PDCCH (referred to as a candidate PDCCH) to determine whether the PDCCH is its own channel by performing CRC error checking.

A BS determines a PDCCH format according to DCI to be transmitted to a UE. Thereafter, the BS attaches a cyclic redundancy check (CRC) to the DCI, and masks a unique identifier (referred to as a radio network temporary identifier (RNTI)) to the CRC according to an owner or usage of the PDCCH.

Now, discontinuous reception (DRX) in a wireless communication system, as example, 3GPP LTE will be described.

The DRX is a method for reducing battery consumption of a UE by allowing the UE to discontinuously monitor a downlink channel.

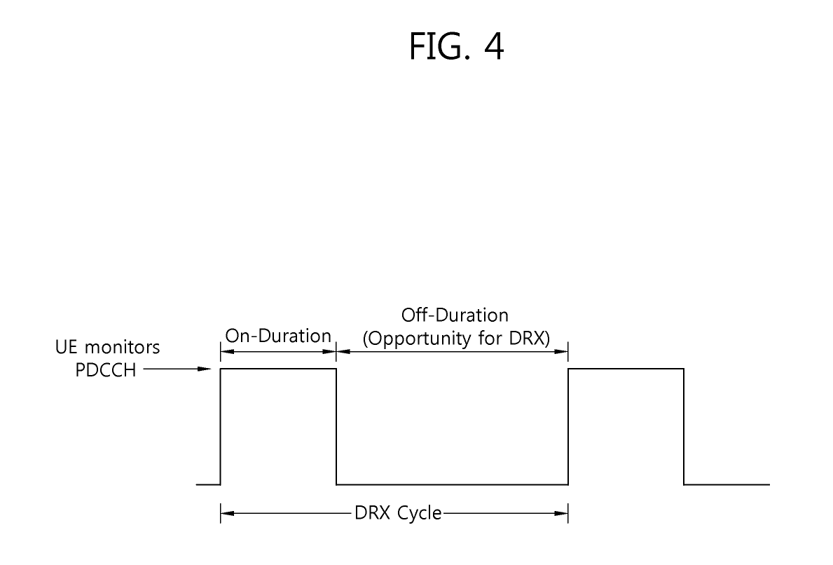

FIG. 4 shows a DRX cycle to which the present invention is applied.

A DRX cycle specifies the periodic repetition of the on-duration followed by a possible period of inactivity. The DRX cyclic includes an on-duration and an off-duration. The on-duration is a duration in which a UE monitors a PDCCH within the DRX cycle. The DRX cycle has two types, i.e., a long DRX cycle and a short DRX cycle. The long DRX cycle which has a long period can minimize battery consumption of the UE. The short DRX cyclic which has a short period can minimize a data transmission delay.

When the DRX is configured, the UE may monitor the PDCCH only in the on-duration and may not monitor the PDCCH in the off-duration.

An onDuration timer is used to define the on-duration. The on-duration can be defined as a duration in which the onDuration timer is running. The onDuration timer may specify the number of consecutive PDCCH-subframe(s) at the beginning of a DRX Cycle. The PDCCH-subframe specifies a subframe in which the PDCCH is monitored.

In addition to the DRX cycle, a duration in which the PDCCH is monitored can be further defined. A duration in which the PDCCH is monitored is collectively referred to as an active time.

A drx-Inactivity timer deactivates the DRX. If the drx-Inactivity timer is running, the UE continuously monitors the PDCCH irrespective of the DRX cycle. The drx-Inactivity timer starts upon receiving an initial UL grant or DL grant on the PDCCH. The drx-Inactivity timer may specify the number of consecutive PDCCH-subframe(s) after successfully decoding a PDCCH indicating an initial UL or DL user data transmission for this UE.

A HARQ RTT timer defines a minimum duration in which the UE expects HARQ retransmission. The HARQ RTT timer may specify the minimum amount of subframe(s) before a DL HARQ retransmission is expected by the UE.

A drx-Retransmission timer defines a duration in which the UE monitors the PDCCH while expecting DL retransmission. The drx-Retransmission timer may specify the maximum number of consecutive PDCCH-subframe(s) for as soon as a DL retransmission is expected by the UE. After initial DL transmission, the UE starts the HARQ RTT timer. When an error is detected for the initial DL transmission, the UE transmits NACK to a BS, stops the HARQ RTT timer, and runs the drx-Retransmission timer. The UE monitors the PDCCH for DL retransmission from the BS while the drx-Retransmission timer is running.

An Active Time can include an on-duration in which the PDCCH is periodically monitored and a duration in which the PDCCH is monitored due to an event occurrence.

When a DRX cycle is configured, the Active Time includes the time while:
onDuration timer or drx-Inactivity timer or drx-Retransmission timer or mac-ContentionResolution timer is running; or
a Scheduling Request is sent on PUCCH and is pending; or
an uplink grant for a pending HARQ retransmission can occur and there is data in the corresponding HARQ buffer; or
a PDCCH indicating a new transmission addressed to the C-RNTI of the UE has not been received after successful reception of a Random Access Response for the preamble not selected by the UE.

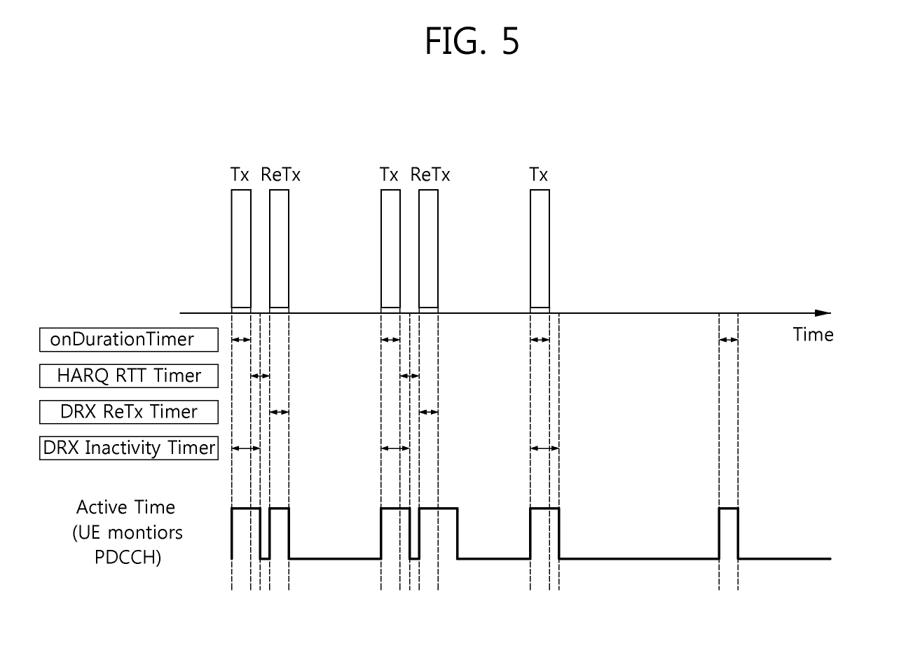

FIG. 5 shows active time for DRX operation to which the present invention is applied.

When DRX is configured, the UE shall for each subframe:
if a HARQ RTT Timer expires in this subframe and the data of the corresponding HARQ process was not successfully decoded:
start the drx-Retransmission timer for the corresponding HARQ process.
if a DRX Command MAC CE (control element) is received:
stop onDuration timer and drx-Inactivity timer.
if drx-InactivityTimer expires or a DRX Command MAC CE is received in this subframe:
if the Short DRX cycle is configured:
start or restart drx-ShortCycle timer and use the Short DRX Cycle.
else:
use the Long DRX cycle.
if drx-ShortCycle timer expires in this subframe:
use the Long DRX cycle.
If the Short DRX Cycle is used and [(SFN*10)+subframe number] modulo (shortDRX-Cycle)=(drxStartOffset) modulo (shortDRX-Cycle); or
if the Long DRX Cycle is used and [(SFN*10)+subframe number] modulo (longDRX-Cycle)=drxStartOffset:
start onDuration timer.
during the Active Time, for a PDCCH-subframe, if the subframe is not required for uplink transmission for half-duplex FDD UE operation and if the subframe is not part of a configured measurement gap:
monitor the PDCCH;
if the PDCCH indicates a DL transmission or if a DL assignment has been configured for this subframe:
start the HARQ RTT timer for the corresponding HARQ process;
stop the drx-Retransmission timer for the corresponding HARQ process.
if the PDCCH indicates a new transmission (DL or UL):
start or restart drx-Inactivity timer.
when not in Active Time, type-0-triggered SRS shall not be reported.
if CQI masking (cqi-Mask) is setup by upper layers:
when onDurationTimer is not running, CQI/PMI/RI/PTI on PUCCH shall not be reported.
else:
when not in Active Time, CQI/PMI/RI/PTI on PUCCH shall not be reported.

As mentioned, the active-time is defined a total duration that the UE is awake. This includes the on-duration of the DRX cycle, the time UE is performing continuous reception while the inactivity timer has not expired and the time UE is performing continuous reception while waiting for a DL retransmission after one HARQ RTT. Based on the above the minimum active time is of length equal to on-duration, and the maximum is undefined (infinite).

A value of HARQ RTT timer is fixed to 8 ms (or 8 subframes). Other timer values (i.e., an onDuration timer, a drx-Inactivity timer, a drx-Retransmission timer, a mac-ContentionResolution timer, etc.) can be determined by the eNB through an RRC message. The eNB can configure the long DRX cycle and the short DRX cycle through the RRC message.

As described above, the UE operates when the UE is configured with DRX, the UE monitors the PDCCH during the Active Time that includes the time while a Scheduling Request is sent on a PUCCH and is pending to perform the DRX with monitoring the PDCCH.

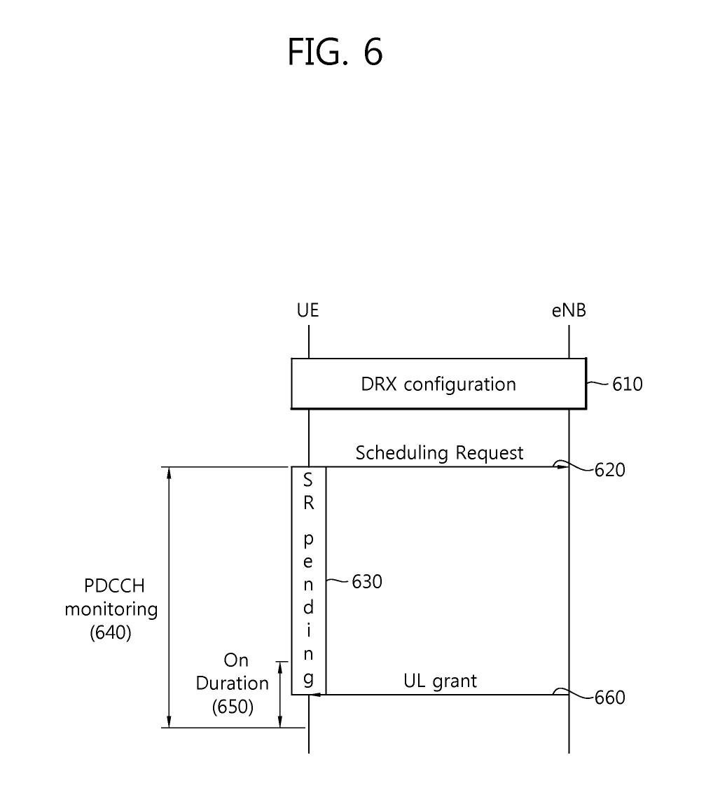

FIG. 6 illustrates one example of monitoring the PDCCH in the wireless communication system.

Referring to FIG. 6, the UE verifies the operation time of the DRX associated timer in accordance with the configuration information of the configured by receiving the RRC signal constituting the DRX configuration information from the base station, calculates a start point of each timer by using the configured offset values, and thereafter, performs the DRX operation (610).

The UE transmits a scheduling request (hereinafter, referred to as SR) to the eNB at a predetermined time (620). Herein, the SR is transmitted through the PUCCH. Meanwhile, the standard defines a section (hereinafter, referred to as SR pending) in which the SR transmitted to be performed) as the active time (630).

As a result, the UE continuously monitors the PDCCH through a plurality of subframes until receiving an uplink grant from the eNB (660) as a response to the SR from the time of the transmitting the SR 620 (640). Herein, as the section in which the UE continuously monitors the PDCCH through the plurality of subframes does not have a predetermined value, the section may be lengthened without any promise.

As one example, FIG. 6 illustrates a case in which the time of receiving the uplink grant from the eNB is onDuration 650 depending on the DRX configuration information received by reference numeral 610.

More details, when the Scheduling Request (SR) is sent on PUCCH and is pending, the UE monitors the PDCCHs to receive the UL grant from the eNB. Upon receiving the SR from the UE, the eNB processes the received SR and then sends UL grant to the UE. The UE may not receive the UL grant immediately after sending the SR to the eNB.

For example, The UE may not receive the UL grant due to the processing time of the received SR at the eNB side. Especially, IDC (In-device coexistence) cases, the eNB schedules the resources for the UE (UL grant, DL assignment) only in the OnDuration. In IDC case, if the UE sends an SR during the OnDuration and cannot receive within that OnDuration, the UE would keep monitoring the PDCCHs outside the OnDuration even though the eNB schedules the resource only in the OnDuration.

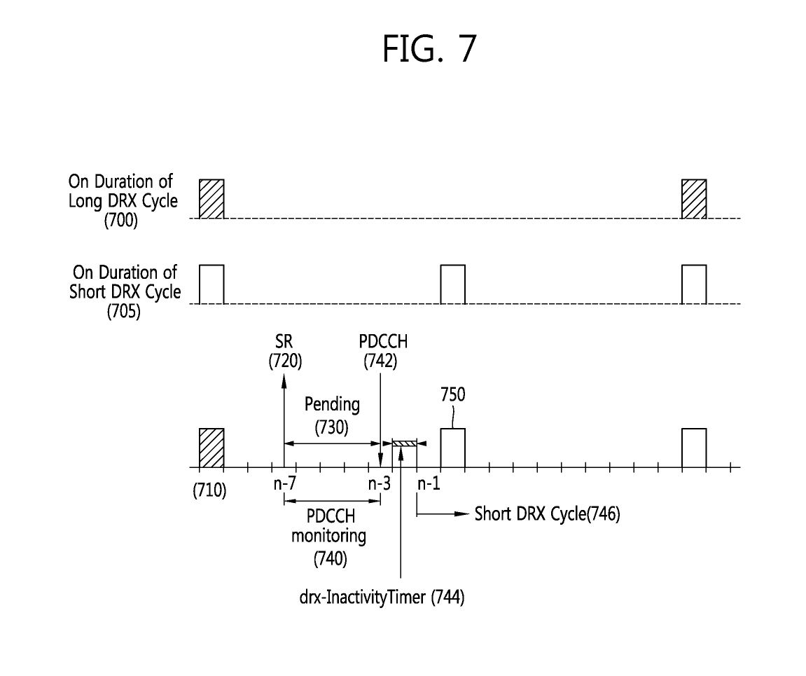

FIG. 7 is a diagram illustrating a time concept of monitoring the PDCCH during the pending section in the current wireless communication system.

Referring to FIG. 7, the UE configures a long DRX cycle 700 and a short DRX cycle 760 by receiving the DRX configuration information in association with DRX functionality from the base station.

The UE monitors during the onDuration 710 calculated according to the configured DRX configuration. Thereafter, in an n−7th subframe, the UE transmits the scheduling request to the eNB (720). In this case, the UE operates during the SR pending until receiving the PDCCH including uplink grant from the eNB in an n−3th subframe as a response to the SR after transmitting the SR 720. Herein, when the UE triggers the SR once, the UE assumes the time until the triggering SR is cancelled as the SR pending.

The SR pending 730 is included in the active time for the DRX during a section for the SR transmission 720 and the SR pending 730, that is, from the n−7th subframe to the n−3th subframe, and as a result, the UE waits for continuously receiving the PDCCH by monitoring the PDCCH from the n−7th subframe to the n−3th subframe.

Meanwhile, when the UE that waits for continuously receiving the PDCCH receives the PDCCH in the n−3th subframe (742), the UE starts to drive (run) a drx-InactivityTimer (1 ms) set at an n−2th subframe by receiving the PDCCH to operate at the active time (744).

Thereafter, when the set drx-InactivityTimer of 1 ms is expired (744), the UE applies a short DRX cycle from an n−1th subframe (746) and monitors the PDCCH during the onDuration 750 by applying a DRX configuration by the short DRX cycle.

In the present invention, as one example, it assumed that the UE receives the PDCCH in the n−3th subframe (742), but after the SR 720 is transmitted in real communication system, a scheduling delay of the eNB can be occurred for the SR processing or especially the UE may not receive the PDCCH at the time of the n−3th subframe under an IDC environment.

For example, when the UE may receive radio resource allocation information at only the onDuration, if the UE transmits the SR to the eNB during the onDuration and thereafter, is disabled to receive the radio resource allocation information during the corresponding onDuration, the UE judges that the SR process is performed, that is, the SR pending is ongoing to continuously monitor the PDCCH. In this case, even though the UE is disabled to receive the radio resource allocation information from the eNB during a section other than the onDuration, the UE continuously monitors the PDCCH all over section. Accordingly, the PDCCH monitoring is an unnecessary and useless operation of power consumption for the UE and it may not be considered as correct DRX.

In other words, even though there is an environment in which the PDCCH may not be received according to the actual existing DRX configuration information and operation of the SR, there is a problem that the PDCCH is unnecessarily monitored.

Therefore, hereinafter, in the present invention, a scheme for controlling the unnecessary PDCCH monitoring operation and performing a more efficient DRX operation of the UE will be proposed. This is to propose the correct DRX operation that matches a purpose and intent of the DRX operation for power consumption.

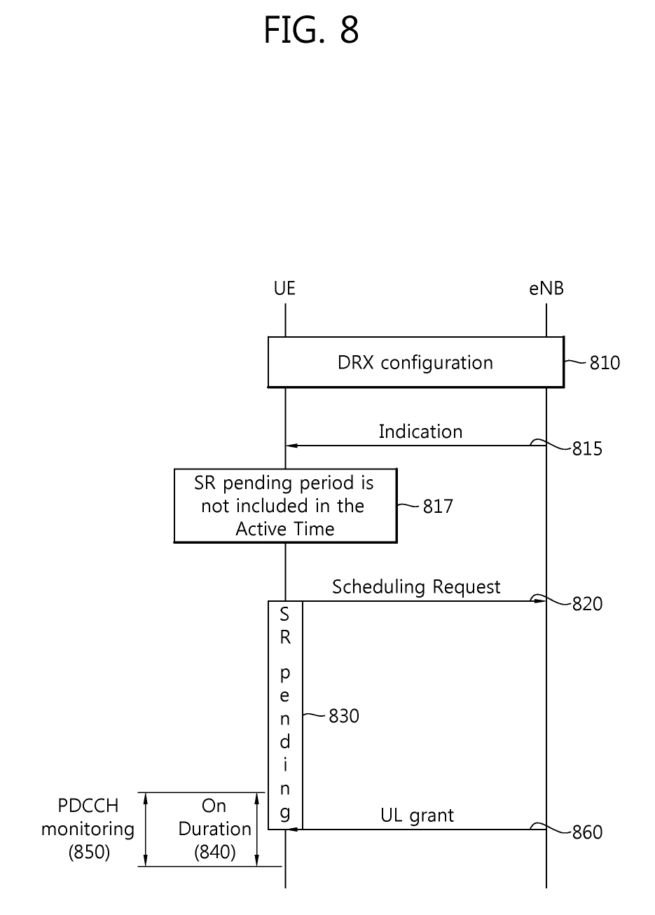

FIG. 8 shows an example of a signaling flow by controlling PDCCH monitoring during a SR pending for a DRX operation according to an exemplary embodiment of the present invention.

Referring to FIG. 8, in 810, the UE receives configuration information for performing the DRX operation from the eNB and configures with DRX functionality. In particular, the UE receives a RRC signal including timers related to the DRX operation and configuration, i.e, the DRX operation is specified by the DRX-config IE (information element) in the RRC signaling, which includes onDurationTimer, drx-InactivityTimer, drx-RetransmissionTimer, drxStartOffset, shortDRX-cycle, and drxShortCycleTimer. The following <Table 1> illustrates the DRX configuration information as an example.

TABLE 1
DRX-Config ::= CHOICE {release NULL, setup SEQUENCE { onDurationTimer
ENUMERATED { psf1, psf2, psf3, psf4, psf5, psf6, ..., psf200}, drx-InactivityTimer
ENUMERATED { psf1, psf2, psf3, psf4, psf5, psf6, ...,psf0-v1020,..., spare2,
spare1}, drx-RetransmissionTimer ENUMERATED { psf1, psf2, psf4, psf6, psf8,
psf16, psf24, psf33}, longDRX-CycleStartOffset CHOICE { sf10 INTEGER(0..9), ...,
sf2560 INTEGER(0..2559)}, shortDRX SEQUENCE { shortDRX-Cycle
ENUMERATED { sf2, sf5, sf8, sf10, sf16, sf20, ..., sf640}, drxShortCycleTimer
INTEGER (1..16) } OPTIONAL -- Need OR }}

As described, the timers for the DRX functionality include onDurationTimer, drx-InactivityTimer, drx-RetransmissionTimer. Each Value of timers such as InactivityTimer and drx-RetransmissionTimer may be defined as the number of predetermined continuous PDCCH subframes. Different psf (PDCCH subframes) values may be configured in accordance with the respective timers.

And Long DRX Cycle configuration information elements include the longDRX-Cycle and the value of the drxStartOffset. The longDRX-CycleStartOffset may determine a starting point based on an interger among predetermined interfers from 0 to N (an interfer larger than 0) in the configured subframe. Optionally, the Short DRX Cycle configuration information elements include the drxShortCycleTimer and shortDRX-Cycle. A period of the shortDRX-Cycle may be defined as the subframe and the drxShortCycleTimer may be defined as one of integers from 0 to 16.

The UE calculates the onDuration time through the DRX configuration information of the received RRC signal, in particular, drxStartOffset and the applied DRX-cycle, and starts the onDurationTimer at a predetermined time. The UE receives the PDCCH during the onDuration by running the onDurationTimer with a predetermined value. According to the present invention, the UE receives an indication for efficiently controlling the DRX operation from the eNB (815).

The indication is an indication for permitting/controlling the PDCCH monitoring to allow the UE not to monitor the PDCCH during the SR pending period which is the time period between the UE triggers a Scheduling Request and the UE cancels the triggered Scheduling Request. The SR pending period can be also defined as the time period while a Scheduling Request is sent on PUCCH and is pending.

Herein, the indication may be sent by a RRC signaling, MAC signalling, or PDCCH. As one example, the indication has a value of 1 (on) to monitor PDCCH during the SR pending otherwise, the indication has a value of 0 (off) not to monitor PDCCH during the SR pending. Therefore, the UE configures the DRX to determine that the SR pending by the SR transmission is not in the active time by considering reception and verification of the indication (817).

Meanwhile, the UE transmits the SR to the eNB in order to request the uplink radio resource allocation (820). In addition, according to the present invention, the UE selectively controls to monitor the PDCCH or not during the SR pending by the indication. Therefore, the UE excludes the SR pending as the SR process executing section from the active time. Further, as a result, the power consumption of the UE is reduced.

Thereafter, the UE determines the onDuration calculated by the DRX configuration (840) and operates at the active time during the onDuration to monitor the PDCCH (850). The UE receives the uplink radio resource allocation information from the eNB during the onDuration (860).

As described above, the UE may determine that the SR pending is not included in the active time according to the indication set in the present invention, and as a result, the UE may control to monitor the PDCCH or not during the SR pending as the SR process executing section. That is, the eNB transmits the indication to the UE and the UE prevents an unnecessary PDCCH monitoring operation through the indication under a communication environment in which the PDCCH is disabled to be actually received after transmitting the SR. Therefore, an efficient DRX operation is performed between the eNB and the UE.

The present invention provides a more efficient DRX operation, for example, in IDC cases under a communication environment that the radio resource allocation information may be received from the eNB during the onDuration. Further, when an SR processing delay occurs in the eNB, the case may be estimated by the eNB and it is indicated to the UE by the indication to control the PDCCH monitoring selectively of the UE and thus, provide an efficient DRX operation of the device therethrough.

Accordingly, the UE selectively includes and excludes the SR pending as and from the active time to control PDCCH monitoring, so that the UE save power of the battery against the unnecessary PDCCH monitoring.

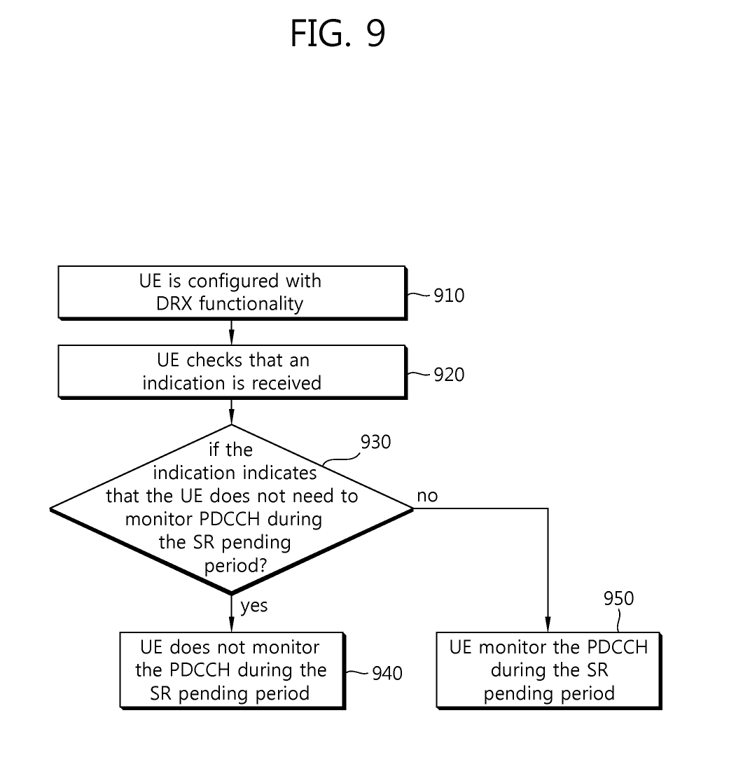

FIG. 9 shows an example of a flow chart by checking an indication for PDCCH monitoring according to an exemplary embodiment of the present invention.

Referring to FIG. 9, the UE is configured to the eNB with DRX functionality by RRC signaling, including onDurationTimer, drx-InactivityTimer, drx-RetransmissionTimer, drxStartOffset, and optinally shortDRX-cycle, drxShortCycleTimer for a DRX operation (910).

More details, when the UE is configured with the DRX functionality that the short DRX Cycle is configured, the UE uses the short DRX Cycle and the UE starts the drxShortCycleTimer. If the short DRX Cycle is not configured, the UE uses the long DRX Cycle.

Herein, if the Short DRX Cycle is used, the UE starts the onDurationTimer at a subframe of [(SFN*10)+subframe number] modulo (shortDRX-Cycle)=(drxStartOffset) modulo (shortDRX-Cycle) subframe. Or if the Long DRX Cycle is used, the UE starts the onDurationTimer at a subframe of [(SFN*10)+subframe number] modulo (longDRX-Cycle)=drxStartOffset.

That is, the UE controls that the onDurationTimer is running at specific subframe using the drxStartOffset and the applied DRX cycle.

The UE checks that it is configured from the eNB not to monitor PDCCH during the SR pending period by means of an indication (920). The indication is sent by using RRC signaling, MAC signaling, or PDCCH. The indication is proposed to allow the UE not to monitor the PDCCH during the SR pending period which is the time period between the UE triggers a Scheduling Request and the UE cancels the triggered Scheduling Request. The SR pending period can be also defined as the time period while a Scheduling Request is sent on a PUCCH and is pending.

If the UE receives this indication from the eNB, and if the indication indicates that the UE does not need to monitor PDCCH during the SR pending period (930, yes), the UE does not monitor the PDCCH during the SR pending period (940). In addition, the definition of Active Time (i.e. the time period where the UE monitors PDCCH) is modified depending on the indication so that the Active Time does not include the SR pending period if the indication indicates that the UE does not need to monitor PDCCH during the SR pending period.

Otherwise, if the indication indicates that the UE allows to monitor PDCCH during the SR pending period (930, no), the UE monitors the PDCCH during the SR pending period (950).

Accordingly, the UE selectively permits and excludes the SR pending period to SR process executing section as and from the active time and controls useless PDCCH monitoring.

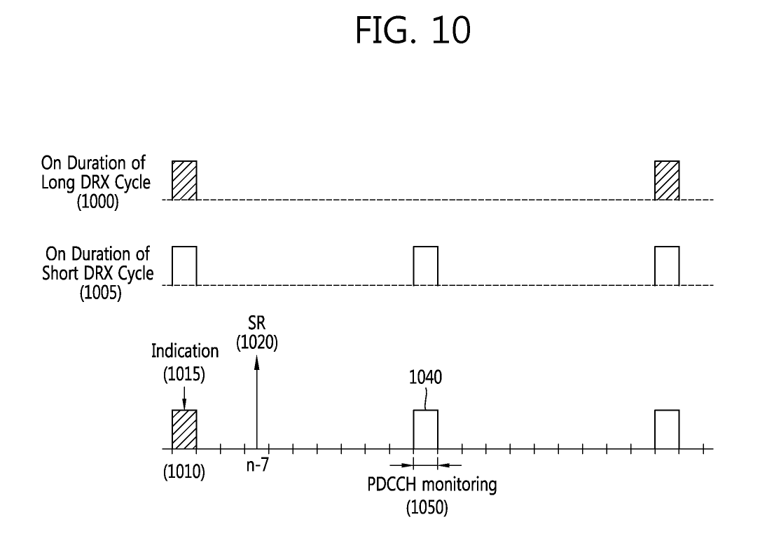

FIG. 10 is a diagram illustrating a time flow for a concept of selectively monitoring the PDCCH during the SR pending section according to the present invention.

Referring to FIG. 10, the UE configures a long DRX cycle 1000 and a short DRX cycle 1005 by receiving the DRX configuration information in association with DRX functionality from the base station.

The UE verifies (determines) onDuration 1010 by the DRX configuration and monitors the PDCCH during the onDuration. In this case, the UE can receives an indication for permitting/controlling the PDCCH monitoring that controls unnecessary PDCCH monitoring not to be performed, from the eNB (1015). According to an embodiment of the present invention, the UE may receive an indication set to prevent the PDCCH monitoring from being performed during an SR pending, that is, the UE may receive the indication indicating to allow the UE not to monitor the PDCCH during the SR pending period which is the time period between the UE triggers a Scheduling Request and the UE cancels the triggered Scheduling Request. Herein, the SR pending period can be also included as the time period while a Scheduling Request is sent on a PUCCH and is pending.

Therefore, the UE transmits the SR to the eNB after triggering the SR in an n−7th subframe (1020) and excludes the SP pending from the active time. That is, the UE operates in offDuration during the SR pending by considering the indication indicating not to monitor the PDCCH.

The UE operates at the active time during the onDuration 1040 of the configured DRX configuration and the UE monitors the PDCCH on the onDuration (1050). That is, the UE receives an uplink grant as a response to the SR transmission (1020) during the onDuration 1040.

Accordingly, the UE minimizes power consumption to match intent of the DRX operation.

Although the aforementioned embodiment shows the DRX operation of the UE for example, the proposed invention is applicable to a DRX operation of a machine to machine (M2M) device or a machine-type communication (MTC) device. MTC is one type of data communication including one or more entities not requiring human interactions. That is, the MTC refers to the concept of communication performed by a machine device, not a terminal used by a human user, by using the existing wireless communication network. The machine device used in the MTC can be called an MTC device. There are various MTC devices such as a vending machine, a machine of measuring a water level at a dam, etc.

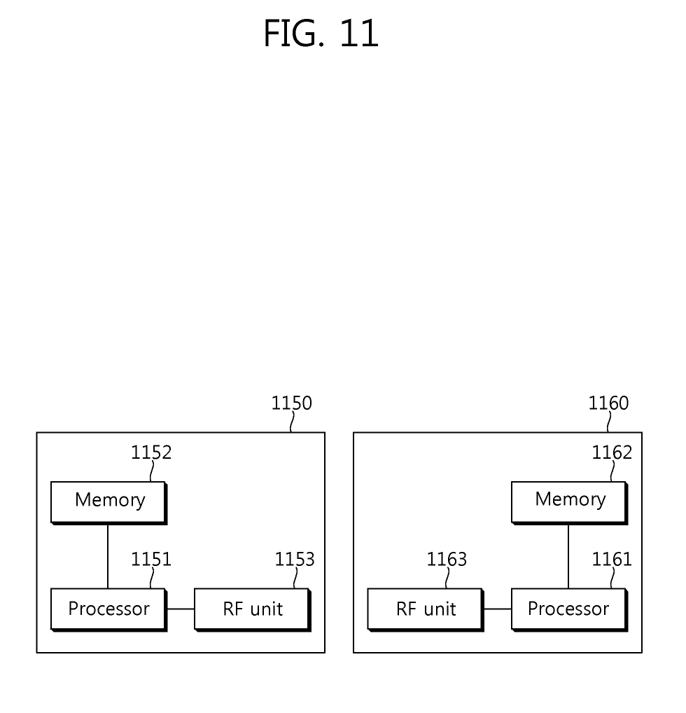

FIG. 11 is a block diagram showing a wireless communication system according to an embodiment of the present invention.

A BS 1150 includes a processor 1151, a memory 1152, and a radio frequency (RF) unit 1153. The memory 1152 is coupled to the processor 1151, and stores a variety of information for driving the processor 1151. The RF unit 1153 is coupled to the processor 1151, and transmits and/or receives a radio signal. The processor 1151 implements the proposed functions, procedures, and/or methods. In the embodiments of FIG. 6 to FIG. 10, the operation of the BS can be implemented by the processor 1151.

More details for this invention, the processor 1151 configures and sets the DRX configuration and CSI transmission configuration with CQI masking on the UE. Herein, the DRX configuration is included to set to UE with both the Short DRX cycle and the Long DRX cycle. The processor 1151 configures with DRX functionality by RRC signaling, including onDurationTimer, drx-InactivityTimer, drx-RetransmissionTimer, drxStartOffset, and optinally shortDRX-cycle, drxShortCycleTimer for a DRX configuration of the UE.

Especially, the processor 1151 also configures an indication to monitor PDCCH during a SR pending period by RRC signaling, MAC signaling, or PDCCH. The processor 1151 can configure the indication that the UE does not need to monitor PDCCH during the SR pending period. The processor 1151 set the indication to allow the UE not to monitor the PDCCH during the SR pending period.

Also, the processor 1151 controls that a PDCCH is not to send the UE during the SR pending period except an Active time. The processor 1151 controls that the onDuration specified in the configured DRX configuration is time to send the UL grant as response of a Scheduling Request triggered from the UE. Then, the processor 1151 can provides DRX configuration more efficiently to the UE.

A wireless device 1160 includes a processor 1161, a memory 1162, and an RF unit 1163. The memory 1162 is coupled to the processor 1161, and stores a variety of information for driving the processor 1161. The RF unit 1163 is coupled to the processor 1161, and transmits and/or receives a radio signal. The processor 1161 implements the proposed functions, procedures, and/or methods. In the embodiments of the FIG. 6 to FIG. 10, the operation of the UE can be implemented by the processor 1161.

More details for this invention, the processor 1161 configures and sets the DRX configuration and CSI transmission configuration with checking the RRC signal by the RF unit 1163. Herein, the DRX configuration is included to set to UE with both the Short DRX cycle and the Long DRX cycle. And the DRX configuration is included to set to UE with only the Long DRX cycle without the Short DRX cycle. The processor 1161 configures with DRX functionality by RRC signaling, including onDurationTimer, drx-InactivityTimer, drx-RetransmissionTimer, drxStartOffset, and optinally shortDRX-cycle, drxShortCycleTimer for a DRX configuration of the UE.

Especially, the processor 1161 also check an indication indicating allow or not to monitor PDCCH during a SR pending period from a RRC signaling, MAC signaling, or PDCCH from the RF unit 1163. The processor 1151 can determine whether the indication that the UE does not need to monitor PDCCH during the SR pending period is not set or not.

The processor 1151 controls that the SR pending period is not the Active time to receive PDCCH(s) to the UE according to the indication. The processor 1151 controls that the onDuration specified in the configured DRX configuration is time to monitor PDCCH(s) for the Scheduling Request. The processor 1151 controls that it receives the UL grant as response of the Scheduling Request triggered at the onDuration.

That is, the processor 1151 can allow the UE not to monitor the PDCCH while the SR is sent and is pending for more efficient DRX operation of the UE, so the UE would keep monitoring the PDCCH on the onDuration when the eNB schedules the resource only in the onDuration, which saves the UE battery life due to excessive monitoring of the PDCCH.

Herein the processor 1161 can be comprised of a checking unit for checking the indication and controller for the SR Pending is not included in the Active time to monitor PDCCHs with the determined indication. Of cause, the processor 1161 can also calculate and apply the new DRX configuration, which means that the starting point and the duration of the timers can be changed by DRX reconfiguration when the modified DRX configuration is received.

The technical concept of the present invention is based on provisional documents as described in the below.

<Start of Priority Document>

When the Scheduling Request (SR) is sent on PUCCH and is pending, the UE monitors the PDCCH to receive the UL grant from the eNB. Upon receiving the SR from the UE, the eNB processes the received SR and then sends UL grant to the UE. The UE may not receive the UL grant immediately after sending the SR to the eNB, for example,
Due to the processing time of the received SR at the eNB side.
In IDC cases, the eNB schedules the resources for the UE (UL grant, DL assignment) only in the On Duration.

In IDC case, if the UE sends an SR during the On Duration and cannot receive within that On Duration, the UE would keep monitoring the PDCCH outside the On Duration even though the eNB schedules the resource only in the On Duration, which saves the battery life due to excessive monitoring of the PDCCH

In current specification, there is no mechanism that allows the UE not to monitor the PDCCH while the SR is sent and is pending.

In this invention, it is proposed to allow the UE not to monitor the PDCCH during the SR pending period which is the time period between the UE triggers a Scheduling Request and the UE cancels the triggered Scheduling Request. The SR pending period can be also defined as the time period while a Scheduling Request is sent on PUCCH and is pending.

The eNB configures the UE not to monitor PDCCH during the SR pending period by means of an indication. The indication is sent by using RRC signalling, MAC signalling, or PDCCH.

If the UE receives this indication from the eNB, and if the indication indicates that the UE does not need to monitor PDCCH during the SR pending period, the UE does not monitor the PDCCH during the SR pending period.

In addition, the definition of Active Time (i.e. the time period where the UE monitors PDCCH) is modified depending on the indication so that the Active Time does not include the SR pending period if the indication indicates that the UE does not need to monitor PDCCH during the SR pending period.

For an implementation, possible changes in the specification (TS 36.321) are described in the below:

When the UE is configured with the DRX functionality, the Active Time includes the time while:

onDurationTimer or drx-InactivityTimer or drx-RetransmissionTimer or mac-ContentionResolutionTimer (as described in subclause 5.1.5) is running; or

If the UE is configured to monitor PDCCH during the time while an Scheduling is sent on PUCCH and is pending;

a Scheduling Request is sent on PUCCH and is pending (as described in subclause 5.4.4); or

an uplink grant for a pending HARQ retransmission can occur and there is data in the corresponding HARQ buffer; or

a PDCCH indicating a new transmission addressed to the C-RNTI of the UE has not been received after successful reception of a Random Access Response for the preamble not selected by the UE (as described in subclause 5.1.4);

<End of Priority Document>

The processor may include application-specific integrated circuit (ASIC), other chipset, logic circuit and/or data processing device. The memory may include read-only memory (ROM), random access memory (RAM), flash memory, memory card, storage medium and/or other storage device. The RF unit may include baseband circuitry to process radio frequency signals. When the embodiments are implemented in software, the techniques described herein can be implemented with modules (e.g., procedures, functions, and so on) that perform the functions described herein. The modules can be stored in memory and executed by processor. The memory can be implemented within the processor or external to the processor in which case those can be communicatively coupled to the processor via various means as is known in the art.

In view of the exemplary systems described herein, methodologies that may be implemented in accordance with the disclosed subject matter have been described with reference to several flow diagrams. While for purposed of simplicity, the methodologies are shown and described as a series of steps or blocks, it is to be understood and appreciated that the claimed subject matter is not limited by the order of the steps or blocks, as some steps may occur in different orders or concurrently with other steps from what is depicted and described herein. Moreover, one skilled in the art would understand that the steps illustrated in the flow diagram are not exclusive and other steps may be included or one or more of the steps in the example flow diagram may be deleted without affecting the scope and spirit of the present disclosure.

1. A method for configuring a Discontinuous Reception (DRX) operation in a wireless communication system, performed by a wireless device, the method comprising:
receiving an indication indicating whether it is need to monitor a physical downlink control channel (PDCCH) or not during a Scheduling Request (SR) pending period; and
controlling to monitor the PDDCH during the SR pending period according to the indication.

2. The method of claim 1, wherein the SR pending period is a time period between the UE triggers the SR and the UE cancels the triggered SR.

3. The method of claim 1, wherein the SR pending period is a time period between the SR is sent on a physical uplink control channel (PUCCH) from a UE to an eNB and is pending before receiving an uplink grant from the eNB.

4. The method of claim 1, further comprising:
modifying an Active Time which is a time period where a UE monitors the PDCCH according to the indication.

5. The method of claim 4, wherein the modifying further comprising:
configuring the Active Time does not include the SR pending period if the indication indicates that the UE does not need to monitor the PDCCH during the SR pending period.

6. The method of claim 5, further comprising:
controlling to not monitor the PDDCH during the SR pending period if the indication indicates that the UE does not need to monitor the PDCCH during the SR pending period.

7. The method of claim 6, wherein the controlling comprising:
controlling to monitor the PDDCH during onDuration which is configured with a drxStartOffset and DRX cycle by a radio resource control (RRC) signaling.

8. The method of claim 1, further comprising:
controlling to monitor the PDDCH during the SR pending period if the indication indicates that the UE is configured to monitor PDCCH during a time while the SR is sent on a PUCCH and is pending.

9. A wireless device for configuring a DRX (Discontinuous Reception) operation in a wireless communication system, comprising:
a radio frequency unit for receiving a radio signal; and
a processor, operatively coupled with the radio frequency unit, configured to:
receive an indication indicating whether it is need to monitor a physical downlink control channel (PDCCH) or not during a Scheduling Request (SR) pending period, and control to monitor the PDDCH during the SR pending period according to the indication.

10. The wireless device of claim 9, wherein the processor is configured to:
determine that the SR pending period is a time period between the UE triggers the SR and the UE cancels the triggered SR, and/or the SR pending period is a time period between the SR is sent on a physical uplink control channel (PUCCH) from a UE to an eNB and is pending before receiving an uplink grant from the eNB

11. The wireless device of claim 9, wherein the processor is configured to:
modify an Active Time which is a time period where a UE monitors the PDCCH according to the indication.

12. The wireless device of claim 11, wherein the processor is further configured to:
configure the Active Time does not include the SR pending period if the indication indicates that the UE does not need to monitor the PDCCH during the SR pending period.

13. The wireless device of claim 12, wherein the processor is further configured to:
control to not monitor the PDDCH during the SR pending period if the indication indicates that the UE does not need to monitor the PDCCH during the SR pending period.

14. The wireless device of claim 13, wherein the processor is further configured to:
control to monitor the PDDCH during onDuration which is configured with a drxStartOffset and DRX cycle by a radio resource control (RRC) signaling.

15. The wireless device of claim 9, wherein the processor is further configured to:
control to monitor the PDDCH during the SR pending period if the indication indicates that the UE is configured to monitor PDCCH during a time while the SR is sent on a PUCCH and is pending.
